(19) United States
(12) Patent Application Publication
(10) Pub. No.: US 2014/0122338 A1
(43) Pub. Date: May 1, 2014

(54) METHOD AND SYSTEM FOR SYSTEM CONTROL

(71) Applicants: Allen Cueli, Miami Lakes, FL (US); Ori Arinze, San Mateo, CA (US); Lori Van DeLoo, Los Altos, CA (US)

(72) Inventors: Allen Cueli, Miami Lakes, FL (US); Ori Arinze, San Mateo, CA (US); Lori Van DeLoo, Los Altos, CA (US)

(21) Appl. No.: 14/012,752

(22) Filed: Aug. 28, 2013

Related U.S. Application Data
(60) Provisional application No. 61/719,896, filed on Oct. 29, 2012.

(51) Int. Cl. G06Q 40/00

(52) U.S. Cl. CPC G06Q 40/00
USPC 705/44; 705/35; 705/39

(57) ABSTRACT

Embodiments of the invention are directed to systems and methods that allow for system control. Certain embodiments allow for creating a hold on an amount of a user's available credit balance and releasing the hold upon the occurrence of an event. Other embodiments allow for the comparison of user transaction history to transaction history of other users having similar demographic characteristics. Further embodiments allow for the conversion of a previously completed transaction to an installment plan.

### CROSS-REFERENCES TO RELATED APPLICATIONS

The present application is a non-provisional application of and claims priority to U.S. Provisional Application No. 61/719,896, filed on Oct. 29, 2012 (Attorney Docket No.: 79900-856100(038500USP1)), the entire contents of which are herein incorporated by reference for all purposes.

### BACKGROUND

Embodiments of the invention are directed to systems and methods that allow for spending control. Consumer use of credit and debit cards for payment transactions continues to increase. This increase has led to more transactions being processed by a financial account, and consequently increased the complexity of account management. A need exists in the art to provide consumers with tools and services to manage their payment card accounts, including benchmarking cardholder spending, establishing savings goals, support for installment payments, and expanded payment options.

Embodiments of the invention address this and other problems, both individually and collectively.

### SUMMARY

Embodiments of the invention broadly described, allow for spending control. More specifically, embodiments of the invention pertain to providing methods for creating a hold on an amount of a user's available credit balance based on a savings goal, comparing spending benchmarks against other users having similar demographic characteristics, and converting a previously completed transaction to an installment plan.

Embodiments of the present invention relate to systems and methods for spending control, specifically allowing the user to initiate actions relating to spending control via a communication device. Certain embodiments of the invention are directed toward a method including receiving, from a communication device, a hold request message requesting to hold an amount of a user's available credit balance, wherein the amount is determined by a savings goal created by the user. A hold may be placed on the amount of the user's available credit balance. The method may include sending, to the communication device, a hold response message indicating that the amount of the user's available credit balance was held. The method may also include releasing the hold on the amount of the user's available credit balance upon the occurrence of an event.

One embodiment of the invention is directed to a method including retrieving, from a database, a set of demographic data about users having similar characteristics to the user. Transaction history of the user may be compared to transaction history of the other users. The comparison and a recommendation of a savings goal based on the comparison may be displayed to the user.

Another embodiment of the invention is directed to a method including receiving an installment information request, wherein the installment information request includes data regarding a previously completed transaction, a user, and one or more parameters relating to terms of an installment plan. A credit worthiness of the user may be determined based on the data. An installment information response may be sent, wherein the installment information response includes one or more proposed installment plans. An installment request may be received, including an installment plan chosen from the one or more proposed installment plans. An installment plan may be established for the previously completed transaction.

Another embodiment of the invention is directed to a device comprising a processor, and a computer readable medium coupled to the processor. The computer readable medium comprises code, executable by the processor, for implementing the above-described methods.

These and other embodiments of the invention are described in further detail below.

### BRIEF DESCRIPTION OF THE DRAWINGS

FIG. 1 is a block diagram of a payment system, according to an embodiment of the present invention.

FIG. 2 is a block diagram of a communication device, according to an embodiment of the present invention.

FIG. 3 is a block diagram of a server computer, according to an embodiment of the present invention.

FIG. 4 is a flow diagram illustrating a method for spending control, according to an embodiment of the present invention.

FIG. 5A shows a screenshot of an exemplary user interface for creating a credit hold on an amount of a user's available balance, via a communication device, according to an embodiment of the present invention.

FIG. 5B shows a screenshot of an exemplary user interface for releasing a credit hold on an amount of a user's available balance, via a communication device, according to an embodiment of the present invention.

FIG. 6A shows a screenshot of an exemplary user interface for selecting a spending category to view spending benchmarks, via a communication device, according to an embodiment of the present invention.

FIG. 6B shows a screenshot of an exemplary user interface for viewing spending benchmarks for a spending category, via a communication device, according to an embodiment of the present invention.

FIG. 7A shows a screenshot of an exemplary user interface for viewing and selecting previous transactions to convert to an installment payment, via a communication device, according to an embodiment of the present invention.

FIG. 7B shows a screenshot of an exemplary user interface for viewing and selecting an installment plan for a previous transaction, via a communication device, according to an embodiment of the present invention.

FIG. 8 is a flow diagram illustrating a method for placing and releasing a hold on a user's available credit balance, according to an embodiment of the present invention.

FIG. 9 is a flow diagram illustrating a method for displaying demographic data to a user including a comparison of spending habits, according to an embodiment of the present invention.

FIG. 10 is a flow diagram illustrating a method for converting a previous transaction to an installment plan, according to an embodiment of the present invention.

FIG. 11 is a diagram of a computer apparatus, according to an example embodiment.

### DETAILED DESCRIPTION

Prior to discussing the specific embodiments of the invention, a further description of some terms can be provided for a better understanding of embodiments of the invention.

A “payment device” may include any suitable device capable of making a payment. For example, a payment device can include a card including a credit card, debit card, charge card, gift card, or any combination thereof. A payment device can be used in conjunction with a communication device, as further defined below.

A “payment processing network” (e.g., VisaNet™) may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™ in particular, includes a VIP system (Visa Integrated Payments system) which processes authorization requests and a Base II system which performs clearing and settlement services.

An “authorization request message” may be an electronic message that is sent to a payment processing network and/or an issuer of a payment card to request authorization for a transaction. An authorization request message according to some embodiments may comply with (International Organization of Standardization) ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CW (card verification value), a dCW (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g. POS equipment) that indicates approval of the transaction. The code may serve as proof of authorization. As noted above, in some embodiments, a payment processing network may generate or forward the authorization response message to the merchant.

A “server computer” can be a powerful computer or a cluster of computers. For example, the server computer can be a large mainframe, a minicomputer cluster, or a group of servers functioning as a unit. In one example, the server computer may be a database server coupled to a Web server.

A “terminal” (e.g. a point-of-service (POS) terminal) can be any suitable device configured to process payment transactions such as credit card or debit card transactions, or electronic settlement transactions, and may have optical, electrical, or magnetic readers for reading data from other portable communication devices such as smart cards, keychain device, cell phones, payment cards, security cards, access cards, and the like.

An “acquirer” can include a business entity (e.g., a commercial bank) that typically has a business relationship with the merchant and receives some or all of the transactions from that merchant.

An “issuer” can include a business entity which issues a card to a user. Typically, an issuer is a financial institution.

A “cardholder” can include a type of user that is authorized to use a payment card issued by the issuer. The terms “cardholder” and “user” may be used interchangeably in the following description. A “user” and/or “cardholder” may be any competent individual.

A “transaction” can include a financial transaction carried out between a user and a merchant involving payment from the user in exchange for information, goods, or services. A transaction may be carried out with a terminal and may be initiated using a payment device. A “previous transaction” may include a financial transaction carried out by the user in the past and already posted to the user's financial account.

“Ring-fencing” can include the separation of a portion of a user's available credit balance without necessarily creating a separate account. Ring-fencing may be used to create a hold on a portion of a consumer's available credit balance. The hold may be created for the purposes of a savings goal whereby the user specifies a portion of their available balance to not be available for regular purchases via their payment card.

“Spend benchmarking” can include the process of comparing a user's spending habits to the spending habits of other individuals having similar characteristics. The spending habits may be compared within a specific spending category, e.g. spending at grocery stores. The characteristics may include age, zip code, family size, etc.

An “installment plan” can include an agreement whereby a user agrees to pay for information, goods, or services in parts or at a percentage at a time. A user may make monthly (or other unit of time) payments towards the purchase price of the information, good, or service purchased on an installment basis.

A “communication device,” as described herein, can include any electronic communication device that can execute and/or support electronic communications including, but not limited to, payment transactions. Some examples include a personal digital assistant (PDA), a smart phone, tablet computer, notebook computer, and the like.

As used herein, a “communications channel” may refer to any suitable path for communication between two or more entities. Suitable communications channels may be present directly between two entities such as a payment processing network and a merchant or issuer computer, or may include a number of different entities. Any suitable communications protocols may be used for generating a communications channel. A communication channel may in some instance comprise a “secure communication channel,” which may be established in any known manner, including the use of mutual authentication and a session key and establishment of a secure socket layer (SSL) session. However, any method of creating a secure channel may be used. By establishing a secure channel, sensitive information related to a payment device (such as account numbers, CVV values, expiration dates, etc.) may be securely transmitted between the two or more entities to facilitate a transaction.

I. Exemplary Systems

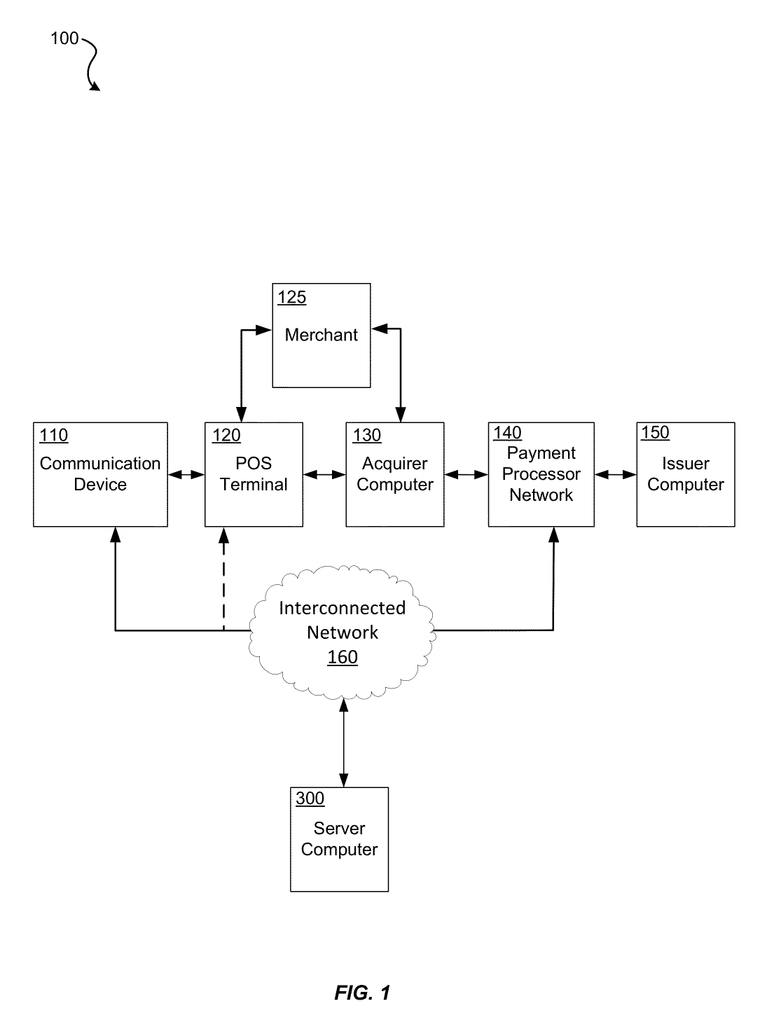

FIG. 1 is a block diagram of a payment system 100, according to one embodiment of the present invention. The system 100 includes a communication device 110, a terminal 120, a merchant 125, an acquirer computer 130, a payment processing network 140, an issuer computer 150, and an interconnected network 160. These components may be operatively coupled together. The acquirer computer 130 may be operated by an acquirer, and the issuer computer 150 may be operated by an issuer. The payment processing network 140 may include an authorization and settlement server and/or additional servers (not shown) to carry out the various transactions described herein.

In an embodiment, the communication device 110 is in electronic communication with the terminal 120. The communication device 110 can be a personal digital assistant (PDA), a smart phone, tablet computer, notebook computer, or the like, that can execute and/or support payment transactions with a payment system 100. A communication device 110 can be used in conjunction with a payment device, such as a credit card, debit card, charge card, gift card, or other payment device and/or any combination thereof. The combination of a payment device (e.g., credit card) and the communication device 110 (e.g., smart phone) can be referred to as the communication device 110 for illustrative purposes. In other embodiments, the communication device 110 may be used in conjunction with transactions of currency or points (e.g., points accumulated in a particular software application). In further embodiments, the communication device 110 may be a wireless device, a contactless device, a magnetic device, or other type of payment device that would be known and appreciated by one of ordinary skill in the art with the benefit of this disclosure. In some embodiments, the communication device 110 includes software (e.g., application) and/or hardware to perform the various spending control methods as further described below.

The terminal 120 is configured to be in electronic communication with the acquirer computer 130 via a merchant 125. In one embodiment, the terminal 120 is a point-of-service (POS) device. Alternatively, the terminal 120 can be any suitable device configured to process payment transactions such as credit card or debit card transactions, or electronic settlement transactions, and may have optical, electrical, or magnetic readers for reading data from portable electronic communication devices such as smart cards, keychain device, cell phones, payment cards, security cards, access cards, and the like. In some embodiments, the terminal 120 is located at and controlled by a merchant. For example, the terminal 120 can be a POS device at a grocery store checkout line. In other embodiments, the terminal could be a client computer or a mobile phone in the event that the user is conducting a remote transaction. In one non-limiting example, the terminal 120 can additionally be used to initiate an installment plan for a payment transaction.

The acquirer (e.g., acquirer bank) includes an acquirer computer 130. The acquirer computer 130 can be configured to transfer data (e.g., bank identification number (BIN), etc.) and financial information to the payment processing network 140. In some embodiments, the acquirer computer 130 does not need to be present in the system 100 for the communication device 110 to transfer the financial and user data to the payment processing network 140. In one non-limiting example, the acquiring bank 130 can additionally check the credentials of the user against a watch list in order to prevent fraud and money laundering schemes, as would be appreciated by one of ordinary skill in the art.

In one embodiment, the payment processing network 140 is VisaNet™, where Visa internal processing (VIP) performs the various payment processing network 140 or multi-lateral switch functions described herein. The payment processing network 140 can include an authorization and settlement server (not shown). The authorization and settlement server (“authorization server”) performs payment authorization functions. The authorization server is further configured to send and receive authorization data to the issuer computer 150.

In some embodiments, the issuer is a business entity which issues a card to a card holder. Typically, an issuer is a financial institution. The issuer computer 150 is configured to receive the authorization data from the payment processing network 140 (e.g., the authorization server). The issuer computer 150 receives authentication data from the authorization server and determines if the user is authorized to perform a given financial transaction (e.g., cash deposit/withdrawal, money transfer, balance inquiry) based on whether the user was authenticated by an identification system.

In some embodiments, the communication device 110 may be connected to and communicate with the payment processor network 140 via an interconnected network 160. One example of an interconnected network 160 is the Internet. The payment processor network 140 may inform the communication device 110 when a payment has been successfully processed. In some embodiments, the payment processor network 140 may be connected to and communicate with the terminal 120 via the interconnected network 160. The payment processor network 140 may inform the terminal 120 when a payment has been successfully processed which in turn the terminal 120 may complete the transaction with the communication device 110.

A server computer 300 is also shown in FIG. 1, and is in operative communication with the interconnected network 160. Details regarding the server computer 300 are provided below.

The interconnected network 160 may comprise one or more of a local area network, a wide area network, a metropolitan area network (MAN), an intranet, the Internet, a Public Land Mobile Network (PLMN), a telephone network, such as the Public Switched Telephone Network (PSTN) or a cellular telephone network (e.g., wireless Global System for Mobile Communications (GSM), wireless Code Division Multiple Access (CDMA), etc.), a VoIP network with mobile and/or fixed locations, a wireline network, or a combination of networks.

In a typical payment transaction in embodiments of the invention, a user may interact with the terminal 120 (e.g., with a payment device such as a payment card, or by entering payment information) to conduct a transaction with the merchant 125. The merchant 125 may be operate a merchant computer, which may route an authorization request message to the acquirer computer 130, and eventually to the issuer computer 150 via the payment processing network 140.

The issuer 140 will then determine if the transaction is authorized (e.g., by checking for fraud and/or sufficient funds or credit). The issuer will then transmit an authorization response message to the terminal 120 via the payment processing network 140 and the acquirer computer 130.

At the end of the day, the transaction is cleared and settled between the acquirer computer 130 and the issuer computer 150 by the payment processing network 140.

The description below provides descriptions of other components in the system as well as methods for spending control. The methods for spending control can be performed at any suitable point during the above-described transaction flow. For example, the spending control methods may be performed before or after the user uses a payment device to interact with the terminal 120.

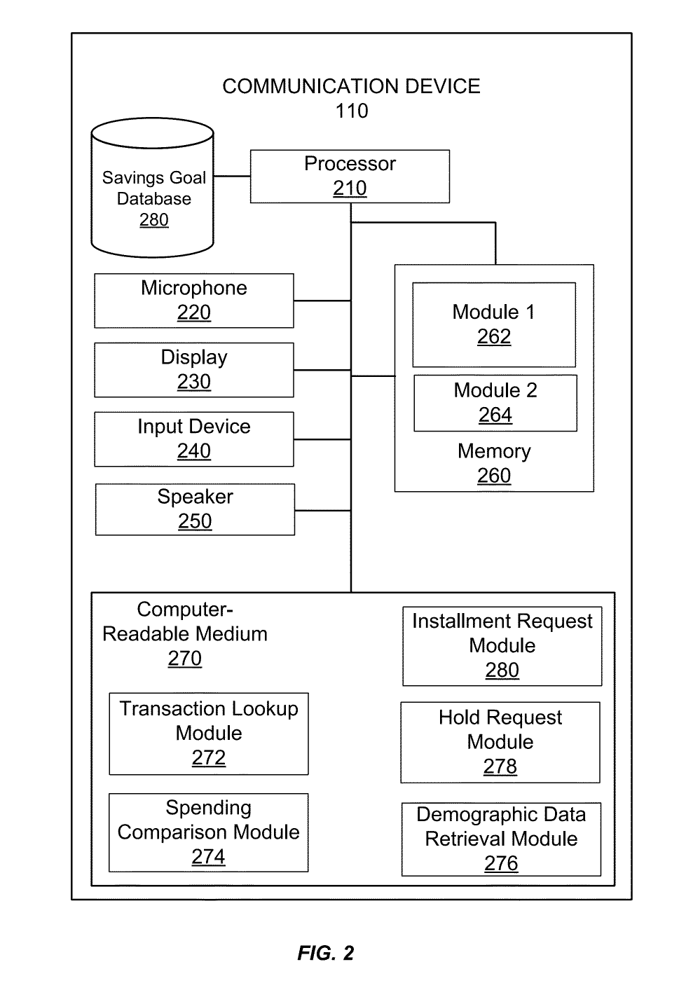

FIG. 2 is a block diagram of a communication device 110, according to an embodiment of the present invention. Communication device 110 includes a processor 210, a microphone 220, a display 230, an input device 240, a speaker 250, a memory 260, and a computer-readable medium 270. Communication device 110 also includes a savings goal database 280.

Processor 210 may be any general-purpose processor operable to carry out instructions on the communication device 110. The processor 210 is coupled to other units of the communication device 110 including microphone 220, display 230, input device 240, speaker 250, memory 260, computer-readable medium 270, and savings goal database 280.

Microphone 220 may be any device that converts sound to an electric signal. In some embodiments, microphone 220 may be used to capture authentication data from a user, e.g. a voice sample.

Display 230 may be any device that displays information to a user. Examples may include an LCD screen, CRT monitor, or seven-segment display.

Input device 240 may be any device that accepts input from a user. Examples may include a keyboard, keypad, or mouse. In some embodiments, microphone 220 may be considered an input device 240.

Speaker 250 may be any device that outputs sound to a user. Examples may include a built-in speaker or any other device that produces sound in response to an electrical audio signal. In some embodiments, speaker 250 may be used to provide audible cues to a user.

Memory 260 may be any magnetic, electronic, or optical memory. Memory 260 includes two memory modules, module 1 262 and module 2 264. It can be appreciated that memory 260 may include any number of memory modules. An example of memory 260 may be dynamic random access memory (DRAM).

Computer-readable medium 270 may be any magnetic, electronic, optical, or other computer-readable storage medium. Computer-readable storage medium 270 includes transaction lookup module 272, spending comparison module 274, demographic data retrieval module 276, hold request module 278, and installment request module 280. Computer-readable storage medium 270 may comprise any combination of volatile and/or non-volatile memory such as, for example, buffer memory, RAM, DRAM, ROM, flash, or any other suitable memory device, alone or in combination with other data storage devices.

Transaction lookup module 272 is configured to cause the communication device 110 to look up and retrieve previous payment transactions initiated by a user. The previous payment transactions may be payment transactions for information, goods, services, etc. The transaction lookup module 272 may query a database to retrieve the previous transactions by the user. The information retrieved about the previous transactions may include, but is not limited to: transaction data such as past merchants associated with the previous transactions, transaction amounts associated with past transactions, payment card information associated with past transactions, locations of past transactions, etc. The transaction lookup module 272 may display the retrieved payment transaction information to the user via display 230.

Spending comparison module 274 is configured to cause the communication device 110 to compare a user's spending to spending by other individuals having similar characteristics. The spending comparison may be performed within a specific category, e.g. spending at grocery stores. The spending comparison module 274 may work in conjunction with demographic data retrieval module 276, which is configured to retrieve demographic data about other individuals. The demographic data may include, but is not limited to, age, family size, income, ZIP code, etc. Demographic data retrieval module 276 may retrieve demographic data from a database. Spending comparison module 274 may make use of the demographic data retrieved by demographic data retrieval module 276 to compile a spending benchmark comparing the user's spending habits to those of other individuals having similar demographic characteristics. As an illustration, spending comparison module 274 may obtain demographic data on the spending levels (e.g., how much is spent using forms of electronic payment) of mothers in households with two children living in a particular zip code. This information may be compared against a particular user's spending level.

Hold request module 278 is configured to cause the communication device 110 to request a hold on a portion of a user's available credit balance. The request may be sent to a payment processor network 140 (FIG. 1) or an issuer computer 150 (FIG. 1). The payment processor network or issuer may “ring-fence” the portion of the user's available credit balance rendering it unusable for payment transactions unless the hold is released. The hold may be placed on the portion of the user's available credit balance in anticipation of a user created savings goal. As an illustration, the user's credit balance may be $1000, and a hold may be placed on $1000 of the user's total credit limit.

Installment request module 280 is configured to cause the communication device 110 to request the conversion of a payment transaction to an installment plan. The payment transaction may be a previous transaction determined by transaction lookup module 272, described above. The request may be sent to a payment processor network 140 (FIG. 1) or an issuer computer 150 (FIG. 1). Further examples of installment plan requests are provided below.

Savings goal database 280 is configured to store a user created savings goal. The savings goal database 280 may include the amount of the savings goal, the target time for reaching the savings goal, etc.

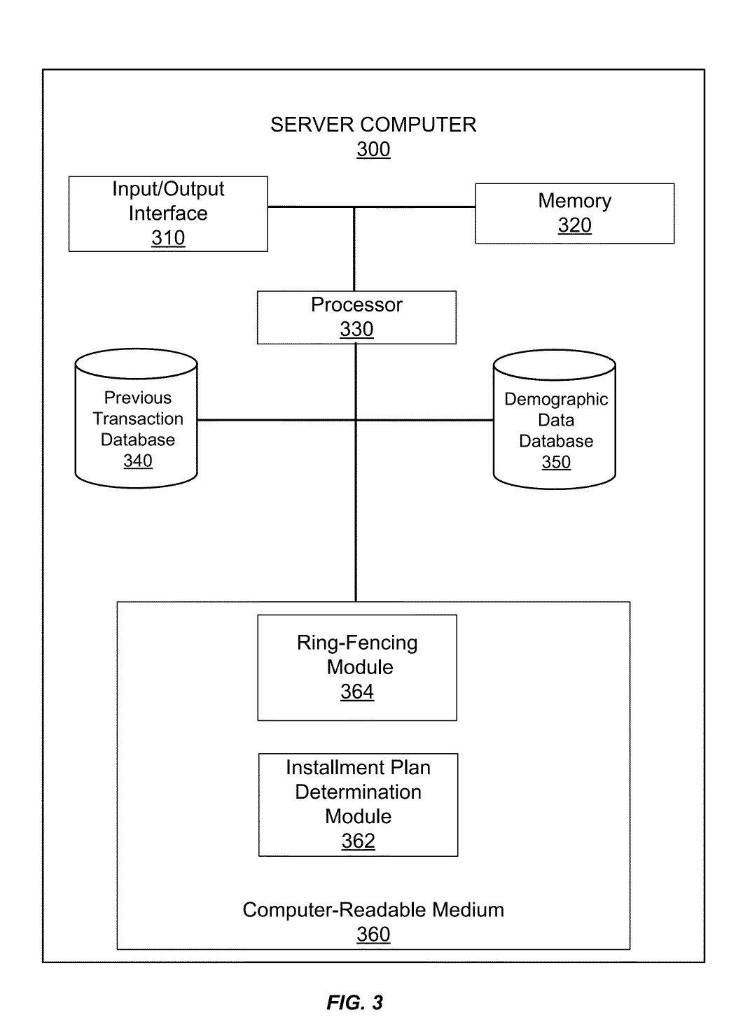

FIG. 3 is a block diagram of a server computer 300, according to an embodiment of the present invention. Server computer 300 includes an input/output interface 310, a memory 320, a processor 330, a previous transaction database 340, a demographics data database 350, and a computer-readable medium 360. In some embodiments, the server computer may reside within the interconnected network 160.

The input/output (I/O) interface 310 is configured to receive and transmit data. For example, the I/O interface 310 may receive requests from the communication device 110 (FIG. 1), via the transaction lookup module 272 (FIG. 2), installment request module 280 (FIG. 2), hold request module 278 (FIG. 2), and/or demographic data retrieval module 276 (FIG. 2). The I/O interface 310 may also be used for direct interaction with the server computer. The I/O interface 310 may accept input from an input device such as, but not limited to, a keyboard, keypad, or mouse. Further, the I/O interface may display output on a display device.

Memory 320 may be any magnetic, electronic, or optical memory. It can be appreciated that memory 320 may include any number of memory modules, that may comprise any suitable volatile or non-volatile memory devices. An example of memory 320 may be dynamic random access memory (DRAM).

Processor 330 may be any general-purpose processor operable to carry out instructions on the server computer 300. The processor 330 is coupled to other units of the server computer 300 including input/output interface 310, memory 320, previous transaction database 340, demographic data database 350, and computer-readable medium 360.

Previous transaction database 340 is configured to store information about previous transactions initiated by the user. The previous transactions include payment transactions for information, goods, services, etc. The information about the previous transactions may include transaction date, transaction amount, payment card information, etc. The previous transaction database 340 may store the information about the transactions either at the time of the transaction or after the transaction is complete. The information may be obtained from the payment processor network 140 (FIG. 1) or the issuer computer 150 (FIG. 1).

The demographic data database 350 is configured to store demographic information and characteristics about a number of other users having similar characteristics to the user. The demographic data may be obtained using paneling methods. The demographic data may include, but is not limited to, age, family size, income, ZIP code, etc. The database 350 may arrange the demographic data by spending category, e.g. spending at grocery stores.

Computer-readable medium 360 may be any magnetic, electronic, optical, or other computer-readable storage medium. Computer-readable storage medium 360 includes installment plan determination module 362 and ring-fencing module 364. Computer-readable storage medium 360 may comprise any combination of volatile and/or non-volatile memory such as, for example, buffer memory, RAM, DRAM, ROM, flash, or any other suitable memory device, alone or in combination with other data storage devices.

Installment plan determination module 362 is configured to determine a number of available installment plans in response to an installment information request from installment request module 280 (FIG. 2). The request for the installment plan may be generated by a user for converting a previously completed transaction, by the user, into an installment plan. The installment plan determination module 362 may reply to the request with a number of possible installment plans. The possible installment plans may be based on, but not limited to, creditworthiness, APR, previous transaction amount, desired installment length, etc. Installment plan determination module 362 may query the payment processor network 140 (FIG. 1) or the issuer computer 150 (FIG. 1) to obtain this information.

Ring-fencing module 354 is configured to place a hold on a portion of a consumer's available credit balance. Ring-fencing module 354 may place this hold in response to a request from hold request module 278 (FIG. 2). The hold may be placed by “ring-fencing” the portion of the user's available credit balance such that the specific credit amount held is not available for payment transactions by the user. Ring-fencing module 354 may communicate with the payment processor network 140 (FIG. 1) or the issuer computer 150 (FIG. 1) to place the hold.

It can be appreciated that in some embodiments the server computer 300 may reside within the payment processor network 140 (FIG. 1).

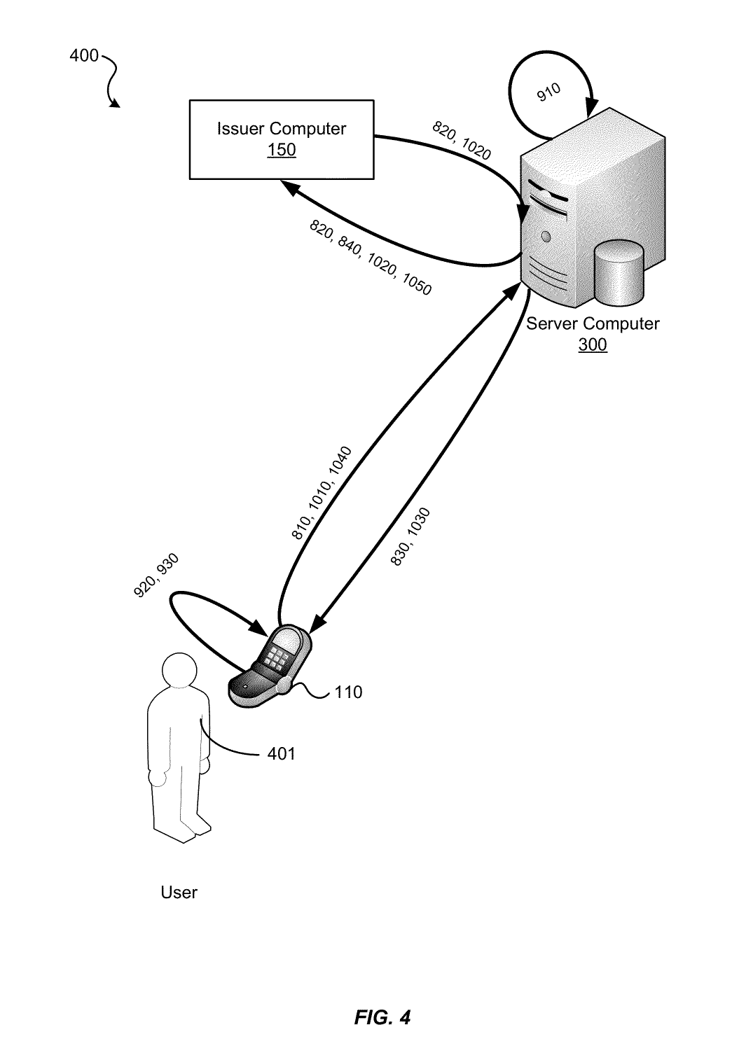

FIG. 4 is a flow diagram 400 illustrating a method for spending control, according to an embodiment of the present invention. In some embodiments, server computer 300 receives, from communication device 110, a hold request message (via hold request module 278 of FIG. 2) requesting to hold an amount of a user's available credit balance. The amount may be determined by a savings goal created by user 401. Server computer 300 may place a hold on the user's available credit by communicating with issuer computer 150 via ring-fencing module 364 (FIG. 3). Upon receiving confirmation from issuer computer 150, the server computer 300 may then send a hold response message to communication device 110 indicating that the amount of the user's available credit balance was held. Communication device 110 may display the hold response message to user 401. Upon the occurrence of an event, the server computer 300 may release the hold on the amount of the user's available credit balance. The occurrence of the event may include, but is not limited to: the completion of a user defined time period, the initiation of a purchase transaction by an authorized merchant, and the initiation of a purchase transaction for a predefined amount. Each of these is described in further detail below.

In some embodiments, the server computer 300 may retrieve, from a demographic data database 350 (FIG. 3) within the server computer 300, a set of demographic data about users having similar characteristics to the user 401. The retrieval may be based on a request received from the communication device 110 via demographic data retrieval module 276 (FIG. 2). The server computer 300 may send the demographic data to the communication device 110. Communication device 110 may compare transaction history of the user to transaction history of the other users based on the demographic data received. The comparison may be carried out using the spending comparison module 274 (FIG. 2). The communication device 110 may display, to the user 401, the comparison and a recommendation of a savings goal based on the comparison. The communication device 110 may present the comparison in a histogram format.

In some embodiments, server computer 300 may receive an installment information request from the communication device 110. The installment information request may be in the form of an e-mail message, text message, etc. The installment information request may be generated by installment request module 280 (FIG. 2). The installment information request may include data regarding a previously completed transaction, a user, and one or more parameters relating to terms of an installment plan. The communication device 110 may obtain a list of previous transactions from previous transaction database 340 (FIG. 3) within the server computer 300. The server computer 300 may then determine a credit worthiness of the user 401. The credit worthiness of the user 401 may be determined via a communication between the server computer 300 and the issuer computer 150. Upon determining the credit worthiness, server computer 300 may send an installment information response to communication device. The installment information response may be in any suitable form (e.g., e-mail message, text message, etc.) and may be generated by installment plan determination module 362 (FIG. 3). The installment information response may include one or more proposed installment plans based on the previously completed transaction. The proposed installment plans may have been determined by installment plan determination module 362 (FIG. 3). The communication device 110 may display the proposed installment plans to the user 401. The server computer 300 may then receive an installment request, from communication device 110, including an installment plan chosen from the one or more proposed installment plans. The server computer 300 may then establish the chosen installment plan for the previously completed transaction. The server computer 300 may communicate with issuer computer 150 to establish the chosen installment plan. The issuer computer 150 may further be configured to execute on the chosen installment plan. For example, if the chosen installment plan is for 2 years, at 13% APR, and a monthly payment of $240.79, the issuer computer 150 may be programmed to bill the user according to this plan. It is further noted that the server computer 300 could run on rules provided by the issuer or may be implemented by the issuer in other embodiments of the invention.

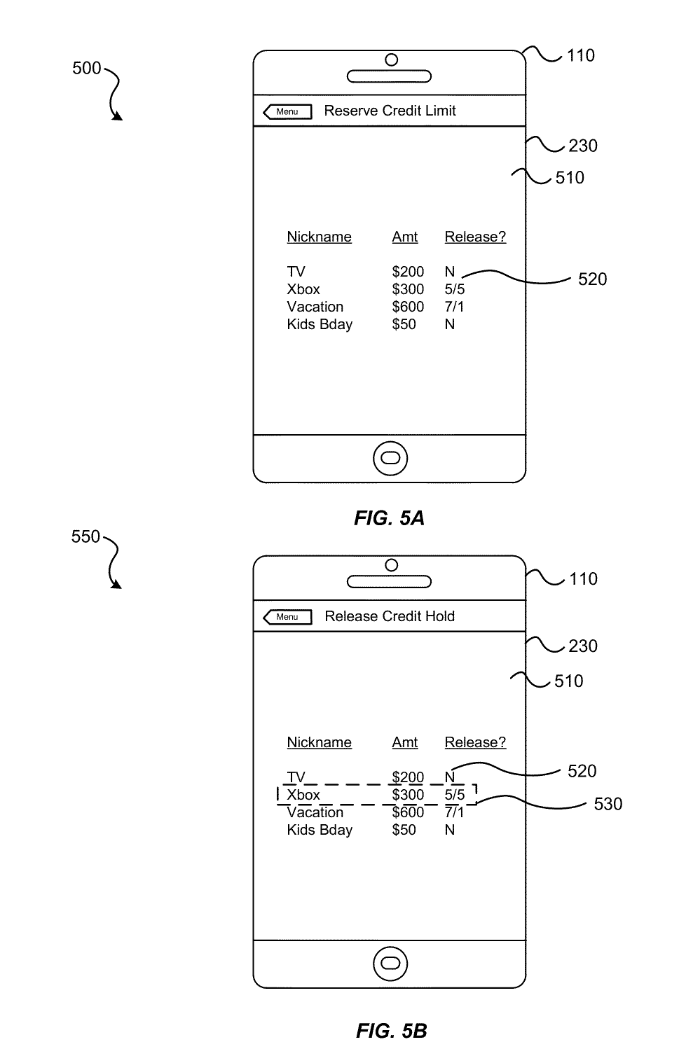

FIG. 5A shows a screenshot 500 of an exemplary user interface 510 for creating a credit hold on an amount of a user's available balance, via a communication device 110, according to an embodiment of the present invention. In some embodiments, the credit hold may be placed for purposes of a goal-based savings feature available on the communication device 110. Goal-based savings enables a user 401 (FIG. 4) to control spending by ring-fencing a portion of the credit open-to-buy balance or debit balance associated with the user's 401 (FIG. 4) financial account. The “fenced amount” may be an amount that is reserved on the consumer's credit or debit account, and that the user 401 (FIG. 4) cannot use. For example, if the user's 401 (FIG. 4) credit account has a credit limit of $1000, a $100 fenced amount may be held. The user 401 (FIG. 4) may then only be able to charge up to a balance of $900 on the account in a single payment period. Any charge that would raise the total balance to over $900 would not be authorized by the issuer.

In some embodiments, ring-fencing allows savings for specific events or items by preventing spending the fenced portion of the credit open-to-buy balance or debit balance except on specific instructions from the user 401 (FIG. 4). In embodiments of the invention, user 401 (FIG. 4) may view and modify existing goals, and create new goals from the communication device 110.

FIG. 5A shows a listing 520 of currently-defined goals within the user interface 510 in one embodiment of the invention. In a typical process, user 401 (FIG. 4) may query the consumer device 110 to view a listing 520 of goals currently defined for a financial account. In response, the consumer device 110 may send a hold request, via hold request module 278 (FIG. 2) to issuer computer 150 (FIG. 1) to receive the corresponding goals. In one embodiment, communication device 110 displays, on the display 230, the received goals within the user interface 510 in a table format. The columns may include a nickname for the goal, a monetary fenced amount, and a release date on which the fenced amount will be released. Alternately, the release date may be set to an indefinite state, whereby the funds are only released upon a specific request by user 401 (FIG. 4). In some embodiments, the funds may be automatically released upon the occurrence of a particular event. The event could include a payment transaction at a preauthorized merchant. For example, a user may specify that the hold be released upon a payment transaction initiated at BestBuy™. In some embodiments, the funds may be automatically released upon a payment transaction for a specified amount. For example, a user may specify that the funds be released upon a transaction amount below $200.

User 401 (FIG. 4) may also add spending goals using communication device 110. To do so, communication device 110 may prompt user 401 (FIG. 4) for a nickname, an amount, and a release date for a new goal. Once this information is received, a hold request may be generated to place a hold for the amount specified for the new goal. The hold request may be sent, via hold request module 278 (FIG. 2), to the issuer computer 150 (FIG. 1). Issuer computer 150 (FIG. 1) may return a hold response which includes an indication of whether the amount was successfully held. If so, the goal may be considered successfully created, and the amount fenced. In some embodiments, the hold request is maintained until the release date for the goal. Thus, the fenced amount may only be released by the issuer on the specified release date or upon other instructions from the user 401 (FIG. 4).

The user interface 510 presented in an example embodiment is shown in FIG. 5A. The user 401 (FIG. 4) has four different spending goals registered: TV, Xbox, Vacation, and Kids Bday. Each spending goal has a set dollar amount to hold from the user's credit balance. Some spending goals have a time-based hold expiration while others do not. The spending goals that do not have a time-based hold expiration may still be automatically released if the user 401 (FIG. 4) defined a preauthorized merchant release or preauthorized amount release, as described above.

Embodiments of the invention may support gradually increasing the fenced amount for a given savings goal. A typical process involves user 401 (FIG. 4) defining a savings goal whereby the fenced amount is to start at certain value immediately, and increase by a fixed amount every payment period thereafter, to a specified maximum. Alternately, the user 401 (FIG. 4) may define a target fenced amount and a future date. The communication device 110 or issuer computer 150 (FIG. 1) may then generate a savings goal whereby the fenced amount increases gradually such that the fenced amount reaches the target fenced amount at the future date. For example, user 401 (FIG. 4) may in October define a savings goal with nickname “TV”, target fenced amount $300, and future date of December 20. Embodiments of the invention may accordingly increase the fenced amount corresponding to the savings goal daily until the $300 is reached on December 20. The fenced amount may then be made available for purchases.

In embodiments of the invention, if user 401 (FIG. 4) opts-in, the issuer computer 150 (FIG. 1) may deliver relevant offers to user 401 (FIG. 4) based on keywords present in the goals.

In some embodiments, the savings goals may be stored within savings goal database 280 (FIG. 2) of the consumer device 110.

FIG. 5B shows a screenshot 550 of an exemplary user interface 510 for releasing a credit hold on an amount of a user's available balance, via a communication device 110, according to an embodiment of the present invention. The user 401 (FIG. 4) may select 530 a previously created savings goal to release the hold on the portion of the user's credit balance. In this example, the $300 hold placed for an Xbox is selected 530 by the user 401 (FIG. 4) to be released. In some embodiments, the communication device 110 may notify the issuer computer 150 (FIG. 1) of the user's intent to release the hold. The issuer computer 150 (FIG. 1) may send an acknowledgment response to the communication device 110 indicating that the hold is released. The communication device 110 may display the acknowledgment to the user 401 (FIG. 4) via the user interface 510. The user 401 (FIG. 4) may then use the released amount to complete a payment transaction, if necessary.

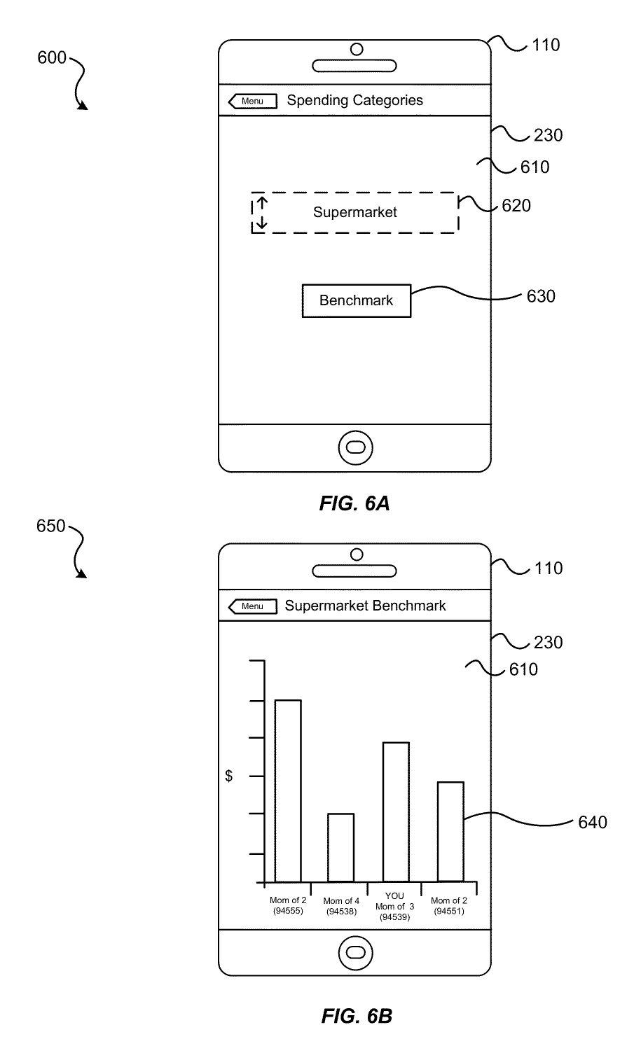

FIG. 6A shows a screenshot 600 of an exemplary user interface 610 for selecting a spending category 620 to view spending benchmarks, via a communication device 110, according to an embodiment of the present invention. The user interface 610, of display 230, may present to user 401 (FIG. 4) benchmarks relating to spending activities by the user (FIG. 4). In one embodiment, the user 401 (FIG. 4) selects a spending category 620 to view spending benchmarks relating to spending activities within the selected category 620. Upon selecting a spending category 620, the user may select a benchmark button 630 to submit their category choice and view the related spending benchmarks.

In some embodiments, the spending category 620 selection box may function as a drop-down menu for selecting the appropriate spending category 620.

FIG. 6B shows a screenshot 650 of an exemplary user interface 610 for viewing spending benchmarks for a spending category, via a communication device, according to an embodiment of the present invention. In some embodiments, the user interface 610, of display 230, of the communication device 110 may display to the user 401 (FIG. 4) their progress relative to a set budget. The communication device 110 may also allow user 401 (FIG. 4) to benchmark their spending relative to similar users having similar characteristics. In one embodiment, user similarity may be determined by demographic data. For example, user 401 (FIG. 4) may compare their supermarket spending against other users with similar family sizes and geographical locations.

For example, the user interface 610 in FIG. 6B shows a histogram 640 of spending benchmarks for supermarket spending. The histogram 640 compares the supermarket spending for mothers with family sizes between two and four. Locality information in terms of ZIP code is also given for each comparison in the histogram 640. In this example, the user 401 (FIG. 4) is a mother of 3 living in ZIP code 94539. Her spending at supermarkets is compared against other mothers. In some embodiments, the other users used for the benchmarking may be within a certain radius of the user 401 (FIG. 4). For example, the benchmark may be performed against other users within a 50 mile radius. By viewing the histogram 640, the user 401 (FIG. 4) may determine whether their spending habits within a certain spending category falls above, equal, or below the spending habits of other users having similar characteristics.

In some embodiments, the demographic data may include, but is not limited to, gender, age, occupation, and income. The demographic data may be obtained using paneling methods whereby a subset of users are polled to determine their spending habits within various spending categories.

In some embodiments, if the user 401 (FIG. 4) feels they require additional information or financial advice, they may click on a button within the user interface 610 to be presented with financial literacy information or other information to assist user 401 (FIG. 4) in managing their finances.

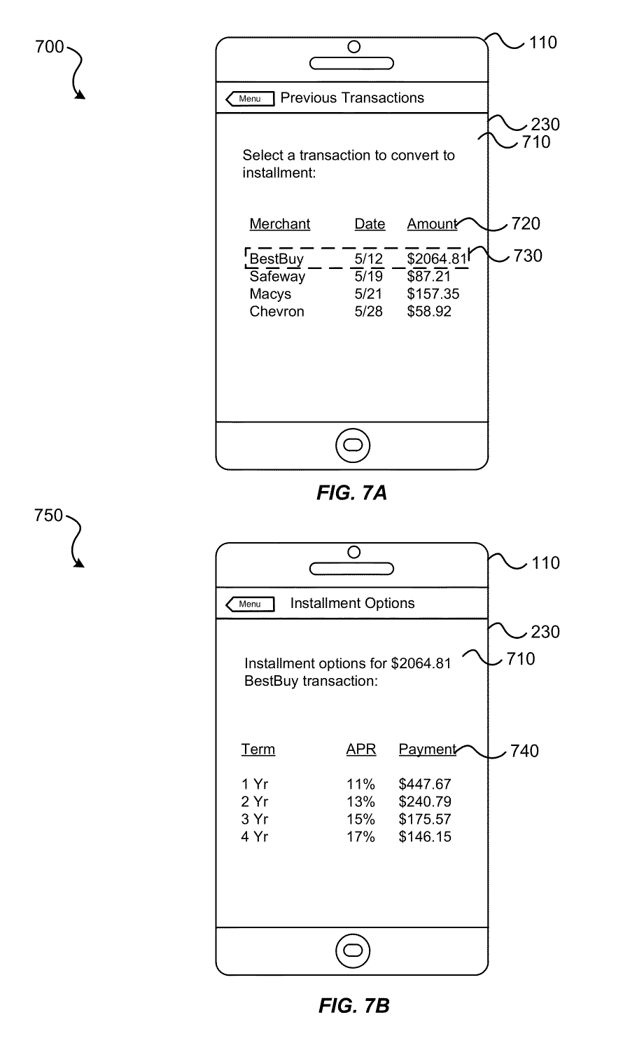

FIG. 7A shows a screenshot 700 of an exemplary user interface 710 for viewing and selecting previous transactions 720 to convert to an installment payment, via a communication device 110, according to an embodiment of the present invention. The user interface 710, of display 230, may be used to convert a previously performed payment transaction to an installment plan using the communication device 110. In an exemplary process, the communication device 110 may request a listing of transactions 720 previously associated with the user's financial account. These transactions may be displayed to the user 401 (FIG. 4) via the user interface 710. An example embodiment of the listing is shown in FIG. 7A. The user 401 (FIG. 4) may then select a transaction 730 and initiate a request to convert the transaction into an installment plan. The user 401 (FIG. 4) may specify desired installment terms such as the desired duration of the plan, the desired monthly payment, the desired number of payments, the desired start and end date, etc. These parameters may be incorporated into an installment conversion information request sent by the installment request module 280 (FIG. 2) and to the issuer computer 150 (FIG. 1) or payment processor network 140 (FIG. 1).

In some embodiments, once the issuer computer 150 (FIG. 1) or payment processor network 140 (FIG. 1) receives the installment conversion information request, the issuer computer 150 (FIG. 1) or payment processor network 140 (FIG. 1) retrieves consumer information for the user 401 (FIG. 4) associated with the installment information request. Retrieved consumer information may include consumer credit rating, qualified APR, and other factors that may indicate the creditworthiness of the user 401 (FIG. 4).

For example, as shown in FIG. 7A, the user 401 (FIG. 4) is presented with a listing of transactions 720 showing four previous transactions. The previous transactions are from a variety of merchants including: BestBuy™, Safeway™ % Macys™, and Chevron™. The listing of transactions 720 also includes a date and an amount for each payment transaction. In this example, the user 401 (FIG. 4) has selected the BestBuy™ transaction of May 2012 in the amount of $2064.81 to be converted into an installment plan, indicated by the dotted selected box around the transaction. In some embodiments, more than one previous transaction from the listing of transactions 720 may be selected for conversion to an installment plan. The conversion plans for multiple transactions may be separate or combined together.

FIG. 7B shows a screenshot of an exemplary user interface 710 for viewing and selecting an installment plan for a previous transaction, via a communication device 110, according to an embodiment of the present invention. The issuer computer 150 (FIG. 1) or payment processor network 140 (FIG. 1) may generate one or more proposed installment plans 740 using the installment information request and the retrieved consumer information, described above. The proposed installment plans 740 are sent to the communication device 110, by server computer 300 (FIG. 3), as part of an installment conversion information response. The communication device 110 may display the proposed installment plans 740 within the user interface 710 of display 230.

Once the communication device 110 receives the installment conversion information response, from installment plan determination module 362 (FIG. 3), the communication device 110 may display the proposed installment plans 740 within the user interface 710. The user 401 (FIG. 4) may then be prompted to choose one of the proposed installment plans 740 to be applied to the previous payment transaction. Alternately, if a single plan is proposed it may automatically be chosen by the consumer device 110. In some embodiments, more than multiple installment plans for more than one previous payment transaction may be shown. The chosen installment plan may then be sent to the issuer computer 150 (FIG. 1) as part of an installment request, so that chosen installment plan is associated with the previous payment transaction. Thus, the full amount of the previous payment transaction is no longer billed to the user's 401 (FIG. 4) account in a lump sum. Rather, billing for the transaction follows the chosen installment plan.

For example, in FIG. 7B, four different installment plan options are given for the $2064.81 BestBuy™ transaction in FIG. 7A. The four different installment plan options offer different payment terms between one year and four years, each having a different annual percentage rate (APR) and corresponding monthly payment. If the user 401 (FIG. 4) selects the 2 year installment plan with a 13% APR, their monthly payment for the installment plan will be $240.79. The user's 401 (FIG. 4) account may then be billed for the monthly amount rather than the entire $2064.81 transaction amount.

In some embodiments, a merchant may bear the risk of authorizing the conversion of a previous transaction to an installment plan. That is, the merchant may be responsible for determining the creditworthiness of the user 401 (FIG. 4) and determining the appropriate installment options to present to the user.

### Exemplary Methods

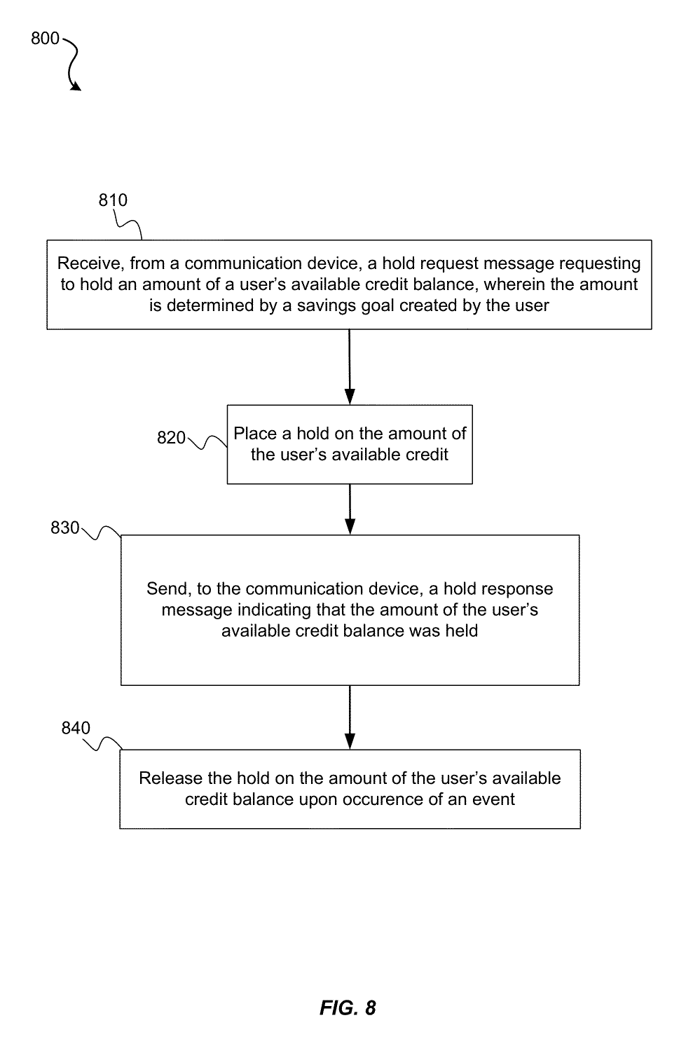

FIG. 8 is a flow diagram illustrating a method for placing and releasing a hold on a user's available credit balance, according to an embodiment of the present invention. The method 800 is performed by processing logic that may comprise hardware (circuitry, dedicated logic, etc.), software (such as is run on a general purpose computing system or a dedicated machine), firmware (embedded software), or any combination thereof. In certain embodiments, the method 800 is performed by the server computer 300 of FIG. 3. The steps of method 800 correspond to the steps in the flow diagram of FIG. 4.

The method 800 includes receiving, from a communication device 110, a hold request message requesting to hold an amount of a user's available credit balance, wherein the amount is determined by a savings goal created by the user 401 (step 810). For example, in FIG. 4, the server computer 300 receives a hold request message from the communication device 110. The amount for the hold request may be specified by the user at the time of the request or may be based on a savings goal created by the user. The ring-fencing module 364 (FIG. 3) within the server computer processes the hold request generated by the hold request module 278 (FIG. 2) of the communication device. In some embodiments, the savings goals may be stored in the savings goal database 280 (FIG. 2) within the communication device 110.

After receiving the hold request message, the method continues by placing a hold on the amount of the user's 401 available credit (step 820). For example, in FIG. 4, after the server computer 300 receives the hold request message from the communication device 100, the ring-fencing module 364 (FIG. 3) may place a hold on the user's 401 available credit. The ring-fencing module 364 (FIG. 3) may communicate with an issuer computer 150 (FIG. 1) or payment processor network 140 (FIG. 1) to process the hold request. For example, with reference to FIG. 1, the server computer 300 may generate preauthorization hold request message and this may be transmitted to the issuer computer 150, and the issuer computer 150 may check to see if there is sufficient credit in the account. The server computer 300 may then transmit a preauthorization hold response message back to the server computer 300 indicating whether or not the pre-authorization hold request was successful or not.

After placing a hold on the amount of the user's 401 available credit, the method continues by sending, by the server computer 300 to the communication device 110, a hold response message indicating that the amount of the user's 401 available credit balance was held (step 830). For example, in FIG. 4, the communication device 110 may display to the user 401 a hold response message received by the server computer 300 indicating that the amount of the user's 401 available credit balance was held. The hold response message may be in response to the hold request message generated in step 810. The hold response message may provide confirmation and other pertinent details about the hold, including confirmation that the amount was successfully “ring-fenced.”

After sending a hold response message, the method continues by releasing the hold on the amount of the user's available credit balance upon occurrence of an event (step 840). For example, in FIG. 4, the server computer 300 may release the hold on the amount of the user's available credit balance in response to the occurrence of various events. Releasing the hold may include the ring-fencing module 364 (FIG. 3) communicating with an issuer computer 150 (FIG. 1) or payment processor network 140 (FIG. 1) to release the hold.

In some embodiments, the event includes the completion of a user defined time period. For example, the user 401 may indicate that the hold be released in 4 months when creating the hold. At the end of 4 months from the creation date, the hold may automatically be released. In some embodiments, the event includes an initiation of a purchase transaction by an authorized merchant. For example, a user may specify that any payment transaction initiated from Wal-Mart may use the ring-fenced or held amount of the user's credit balance. Upon initiation of the payment transaction from Wal-Mart, the hold on the user's credit may be released. In some embodiments, the event includes an initiation of a purchase transaction for a predefined amount. For example, a user may specify that any payment transaction exceeding $500 may use the ring-fenced or held amount of the user's credit balance. Upon initiation of a payment transaction over $500, the hold on the user's credit may be released.

It should be appreciated that the specific steps illustrated in FIG. 8 provide a particular method for placing and releasing a hold on a user's available credit balance, according to an embodiment of the present invention. Other sequences of steps may also be performed according to alternative embodiments. For example, alternative embodiments of the present invention may perform the steps outlined above in a different order. Moreover, the individual steps illustrated in FIG. 8 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the method 800.

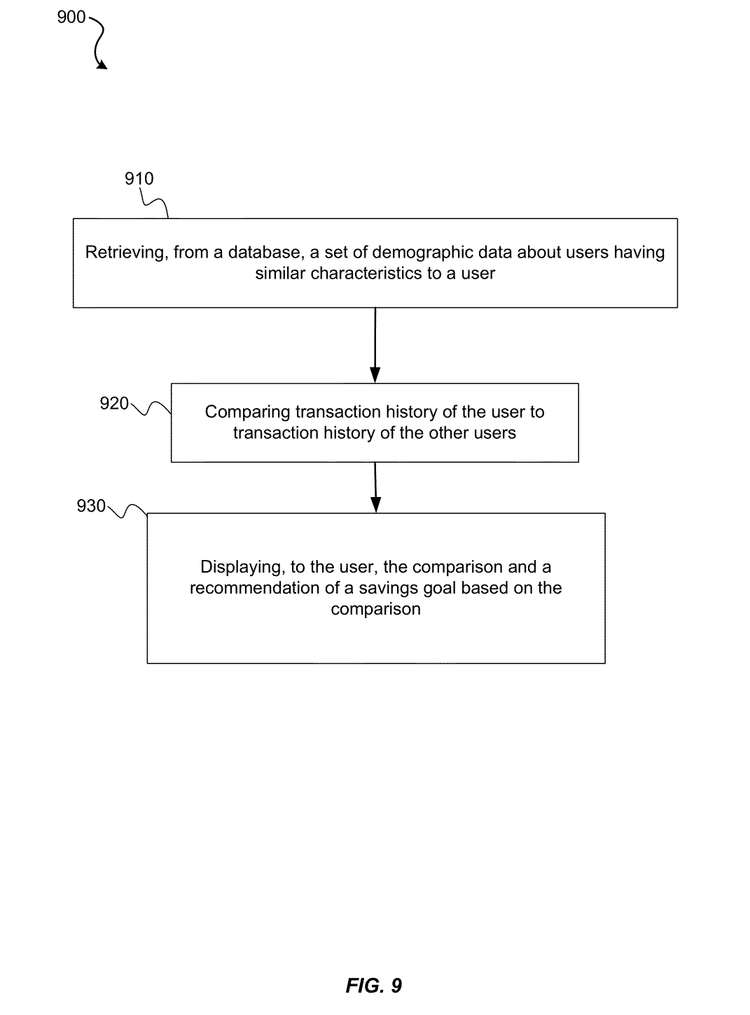

FIG. 9 is a flow diagram illustrating a method for displaying demographic data to a user including a comparison of spending habits, according to an embodiment of the present invention. The method 900 is performed by processing logic that may comprise hardware (circuitry, dedicated logic, etc.), software (such as is run on a general purpose computing system or a dedicated machine), firmware (embedded software), or any combination thereof. In certain embodiments, the method 900 is performed by the server computer 300 of FIG. 3. The steps of method 900 correspond to the steps in the flow diagram of FIG. 4.

The method 900 includes retrieving, from a database, a set of demographic data about users having similar characteristics to a user (step 910). For example, in FIG. 4, upon receiving a request initiated by the user and via the demographic data retrieval module 276 (FIG. 2), the server computer may retrieve demographic data about other user's having similar characteristics to the user. In some embodiments, the demographic data may be stored in a demographic data database 350 (FIG. 3). The demographic data may include user ZIP code, user age, user gender, user income, user family size, and merchant category.

After retrieving the demographic data, the method continues by comparing transaction history of the user to transaction history of the other users (step 920). For example, in FIG. 4, after retrieving the demographic data, the method continues by comparing transaction history of the user to transaction history of the other users based on the retrieved demographic data. The comparison may include comparisons based on user ZIP code, user age, user gender, user income, user family size, and merchant category. For example, the comparison may compare transaction history (spending) of two users of the same age and family size at grocery stores.

After comparing the transaction history, the method continues by displaying, to the user, the comparison and a recommendation of a savings goal based on the comparison (step 930). For example, in FIG. 4, after receiving the demographic data from the server computer 300, the communication device 110 may compare the demographic data using spending comparison module 274 and display the comparison on a display of the communication device 110 for the user to view. The comparison may include displaying a histogram including the comparison of transaction history of the user and other users.

It should be appreciated that the specific steps illustrated in FIG. 9 provide a particular method for displaying demographic data to a user including a comparison of spending habits, according to an embodiment of the present invention. Other sequences of steps may also be performed according to alternative embodiments. For example, alternative embodiments of the present invention may perform the steps outlined above in a different order. Moreover, the individual steps illustrated in FIG. 9 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the method 900.

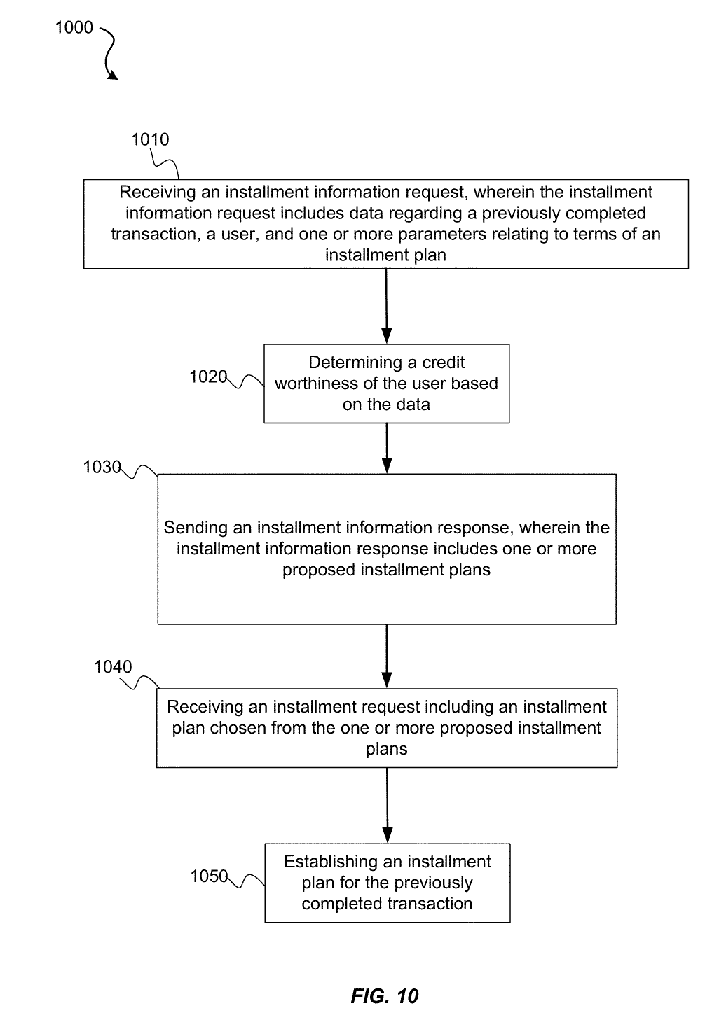

FIG. 10 is a flow diagram illustrating a method for converting a previous transaction to an installment plan, according to an embodiment of the present invention. The method includes receiving an installment information request, wherein the installment information request includes data regarding a previously completed transaction, a user, and one or more parameters relating to terms of an installment plan (step 1010). For example, in FIG. 4, the server computer 300 may receive an installment information request, generated by installment request module 280 (FIG. 2) of communication device 110. The installment information request may include data about a previously completed transaction, the user of the communication device 110, and one or more parameters relating to terms of an installment plan. In some embodiments, the data about a previously completed transaction may have been retrieved from the previous transaction database 340 (FIG. 3) of server computer 300 by transaction lookup module 272 (FIG. 2) on the communication device 110.

After receiving the installment information request, the method continues by determining a credit worthiness of the user based on the data (step 1020). For example, in FIG. 4, the server computer 300 may determine a credit worthiness of the user by using the installment plan determination module 362 (FIG. 3) to communicate with an issuer computer 150 (FIG. 1) or payment processor network 140 (FIG. 1) to determine the credit worthiness of the user. The credit worthiness of the user may be based on prior financial history with the issuer. It can be appreciated that step 1020 is optional and not required in certain scenarios. For example, the determination of creditworthiness may occur upon the user signing up with the system.

After determining a credit worthiness of the user based on the data, the method continues by sending an installment information response, wherein the installment information response includes one or more proposed installment plans (step 1030). For example, in FIG. 4, after the server computer 300 determines the credit worthiness of the user, the installment plan determination module 362 (FIG. 3) may determine various installment plans that the user may be eligible to convert the previous payment transaction to. These installment plans may be sent to the communication device 110 and received by the installment request module 280 (FIG. 2). The communication device 110 may display the available installment plan options to the user and the user may select one of the options.

After sending an installment information response, the method continues by receiving an installment request including an installment plan chosen from one or more proposed installment plans (step 1040). For example, in FIG. 4, the server computer 300 may receive an installment request form the communication device 110 including the user's selected installment plan option. The installment request may be received by installment plan determination module 362 (FIG. 3) of server computer 300.

After receiving an installment request, the method continues by establishing an installment plan for the previously completed transaction (step 1050). For example, in FIG. 3, after receiving the installment request, the server computer 300 may establish an installment plan for the previously completed transaction by converting the amount of the transaction to installment payments. The server computer 300 may communicate with an issuer computer 150 (FIG. 1) or payment processor network 140 (FIG. 1) to convert the previously completed transaction to an installment plan.

It should be appreciated that the specific steps illustrated in FIG. 10 provide a particular method for converting a previous transaction to an installment plan, according to an embodiment of the present invention. Other sequences of steps may also be performed according to alternative embodiments. For example, alternative embodiments of the present invention may perform the steps outlined above in a different order. Moreover, the individual steps illustrated in FIG. 10 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the method 1000.

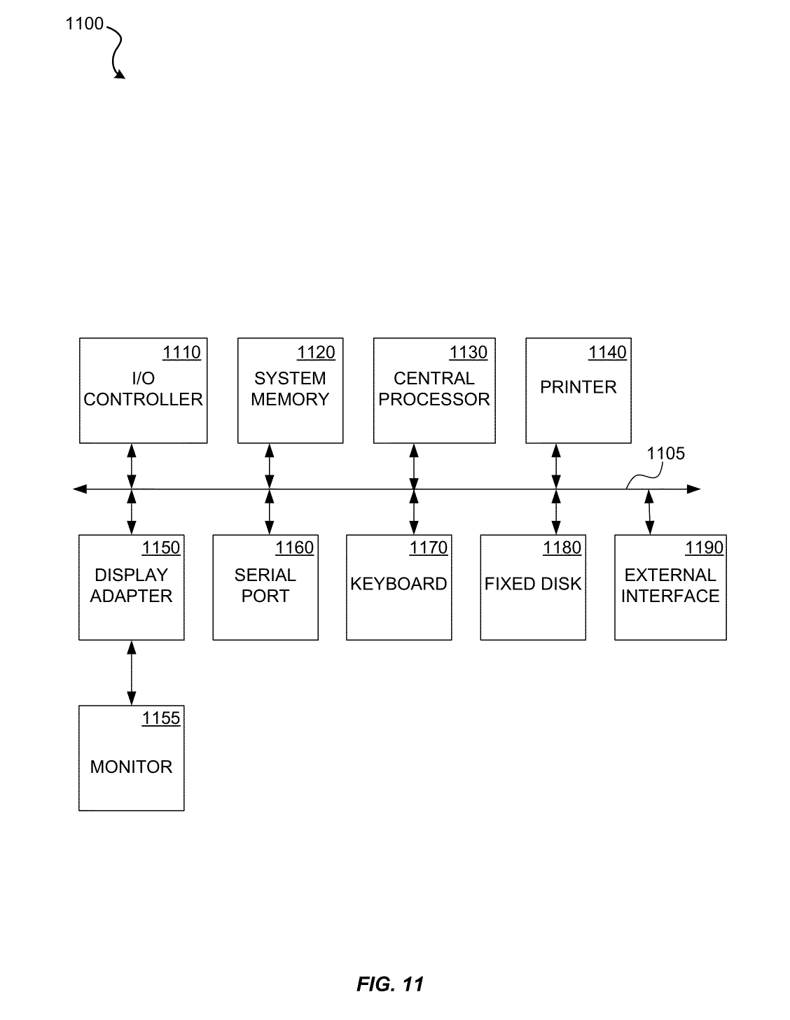

FIG. 11 is a diagram of a computer apparatus 1100, according to an example embodiment. The various participants and elements in the previously described system diagram (e.g., the communication device, payment processing network, acquiring bank, issuing bank, etc., in FIG. 1 or the server computer in FIG. 3) may use any suitable number of subsystems in the computer apparatus to facilitate the methods and/or functions described herein. Examples of such subsystems or components are shown in FIG. 11. The subsystems shown in FIG. 11 are interconnected via a system bus 1105. Additional subsystems such as a printer 1140, keyboard 1170, fixed disk 1180 (or other memory comprising computer-readable media), monitor 1155, which is coupled to display adapter 1150, and others are shown. Peripherals and input/output (I/O) devices (not shown), which couple to I/O controller 1110, can be connected to the computer system by any number of means known in the art, such as serial port 1160. For example, serial port 1160 or external interface 1190 can be used to connect the computer apparatus to a wide area network such as the Internet, a mouse input device, or a scanner. Alternatively, peripherals can be connected wirelessly (e.g., IR, Bluetooth, etc.). The interconnection via system bus allows the central processor 1130 to communicate with each subsystem and to control the execution of instructions from system memory 1120 or the fixed disk 1180, as well as the exchange of information between subsystems. The system memory 1120 and/or the fixed disk 1180 (e.g., hard disk, solid state drive, etc.) may embody a computer-readable medium.

The software components or functions described in this application may be implemented as software code to be executed by one or more processors using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The present invention can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

In embodiments, any of the entities described herein may be embodied by a computer that performs any or all of the functions and steps disclosed.

Any recitation of “a”, “an” or “the” is intended to mean “one or more” unless specifically indicated to the contrary.

One or more embodiments of the invention may be combined with one or more other embodiments of the invention without departing from the spirit and scope of the invention.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A method, comprising:
receiving, by a processor and from a communication device, a hold request message requesting to hold an amount of a user's available credit balance, wherein the amount is determined by a savings goal created by the user;
placing, by the processor, a hold on the amount of the user's available credit balance;
sending, to the communication device, a hold response message indicating that the amount of the user's available credit balance was held; and
releasing, by the processor, the hold on the amount of the user's available credit balance upon the occurrence of an event.

2. The method of claim 1, wherein the event comprises the completion of a user defined time period.

3. The method of claim 1, wherein the event comprises an initiation of a purchase transaction by an authorized merchant.

4. The method of claim 1, wherein the event comprises an initiation of a purchase transaction for a predefined amount.

5. The method of claim 1, further comprising:
retrieving, from a database, a set of demographic data about users having similar characteristics to the user;
comparing transaction history of the user to transaction history of the other users; and
displaying, to the user, the comparison and a recommendation of the savings goal based on the comparison.

6. The method of claim 5, wherein the comparison is based on at least one of a user ZIP code, user age, user gender, user income, user family size, and merchant category.

7. The method of claim 5, wherein the displaying further comprises displaying a histogram comprising transaction history of the user and other users retrieved from the database.

8. A device, comprising:
a processor; and
a non-transitory computer-readable storage medium, comprising code executable by the processor for implementing a method for authenticating a user for a transaction, the method comprising:
receiving, from a user device, a hold request message requesting to hold an amount of a user's available credit balance, wherein the amount is determined by a savings goal created by the user;
placing a hold on the amount of the user's available credit balance;
sending, to the user device, a hold response message indicating that the amount of the user's available credit balance was held; and
releasing the hold on the amount of the user's available credit balance upon the occurrence of an event.

9. The device of claim 8, wherein the event comprises the completion of a user defined time period.

10. The device of claim 8, wherein the event comprises an initiation of a purchase transaction by an authorized merchant.

11. The device of claim 8, wherein the event comprises an initiation of a purchase transaction for a predefined amount.

12. The device of claim 8, wherein the method further comprises:
retrieving, from a database, a set of demographic data about users having similar characteristics to the user;
comparing transaction history of the user to transaction history of the other users; and
displaying, to the user, the comparison and a recommendation of the savings goal based on the comparison.

13. The device of claim 12, wherein the comparison is based on at least one of a user ZIP code, user age, user gender, user income, user family size, and merchant category.

14. The device of claim 12, wherein the displaying further comprises displaying a histogram comprising transaction history of the user and other users retrieved from the database.

15. A method, comprising:
receiving, by a processor, an installment information request, wherein the installment information request includes data regarding a previously completed transaction, a user, and one or more parameters relating to terms of an installment plan;
determining, by the processor, a credit worthiness of the user based on the data;
sending, by the processor, an installment information response, wherein the installment information response includes one or more proposed installment plans;
receiving, by the processor, an installment request including an installment plan chosen from the one or more proposed installment plans; and
establishing, by the processor, an installment plan for the previously completed transaction.

16. The method of claim 15, further comprising displaying, to the user, the one or more proposed installment plans.

17. The method of claim 15, wherein the installment information request is received by a communication device.

18. A device, comprising:
a processor; and
a non-transitory computer-readable storage medium, comprising code executable by the processor for implementing a method for authenticating a user for a transaction, the method comprising:
receiving an installment information request, wherein the installment information request includes data regarding a previously completed transaction, a user, and one or more parameters relating to terms of an installment plan;
determining a credit worthiness of the user based on the data;
sending an installment information response, wherein the installment information response includes one or more proposed installment plans;
receiving an installment request including an installment plan chosen from the one or more proposed installment plans; and
establishing an installment plan for the previously completed transaction.

19. The method of claim 18, wherein the method further comprises displaying, to the user, the one or more proposed installment plans.

20. The method of claim 18, wherein the installment information request is received by a communication device.
